(19) United States
(12) Patent Application Publication
(10) Pub. No.: US 2005/0155596 A1
(43) Pub. Date: Jul. 21, 2005

(54) Transportable grill

(76) Inventors: David M. Andrews, Lexington, KY (US); Brian S. McMurtry, Terre Haute, IN (US)

Correspondence Address: REED SMITH LLP, 2500 ONE LIBERTY PLACE, 1650 MARKET STREET, PHILADELPHIA, PA, 19103, US

(21) Appl. No.: 10/945,842

(22) Filed: Sep. 21, 2004

Related U.S. Application Data
(63) Continuation-in-part of application No. 10/652,722, filed on Aug. 29, 2003.

(51) Int. Cl. A47J 37/00

(52) U.S. Cl. 126/25 R; 126/41 R

(57) ABSTRACT

The present invention is a grill having a novelty aspect achieved by the application of themed coating to at least a portion of an upper portion of the grill unit, wherein the upper portion includes an inner shell to limit the heat to which the outer shell is exposed to reduce the thermal characteristic to which the outer coating is exposed. In additional embodiments, the grill may be formed with features to enable transportability of the grill, such as where the grill is used for grilling purposes at sporting events.

### PRIORITY INFORMATION

The present application is a continuation-in-part of U.S. patent application Ser. No. 10/652,722, filed on Aug. 29, 2003.

### FIELD OF THE INVENTION

The present invention pertains to grills for cooking foods, and more particularly, to novelty grills, such as for use at sporting events.

### BACKGROUND OF THE INVENTION

Sporting events may include pre-game festivities that occur in parking lots. These festivities are frequently oriented towards a particular participant in the sporting event, such as a football team. Support for such a team is frequently demonstrated through the display of novelty items displaying the teams colors or logos.

Another tradition of such festivities includes the preparation of barbecue-cooked food. Barbecue grills that are formed to display support for a participant may take the form of a symbol or logo associated with a team, or may more simply be coated with a teams colors. As the grill is typically used for cooking, any coatings used to produce the logos or coloration associated with a team must be able to withstand the temperatures to which the coating may be exposed when the grill is in use. Additional requirements associated with such coatings include the necessity for the coating to be rugged enough to withstand the wear and tear associated with usage of the grill, especially where the grill is implemented in a fashion such as to be portable, such as when engaged to the trailer hitch received of a vehicle.

The upper surfaces of the grill may typically be the surfaces upon which such team colors or orientation may be desired to be placed, such as where the upper portion of the grill is shaped to resemble a football helmet. As heat created by a heating element within the grill (such as burning charcoal briquettes or a natural gas or propane burner) is transferred to the upper portion of the grill, as a result of conduction through the environment within the grill, as well as through radiant transfer from the combustion itself, the upper surfaces of the grill tend to become quite heated. Although the outer surface of the upper portion is exposed to ambient air, the coatings applied to create an insulative layer, such that the temperature of the substrate to which the coating has been applied is actually somewhat insulated from the ambient air.

Typical coatings may undergo adverse transformations when certain temperatures/thresholds associated with the coating are achieved. The adverse transformations may include color changes, or embrittlement of the coating. The ability to increase the temperature threshold at which such transformations occur may be accomplished, however may also come at an increased cost. Where the coatings are intended for ornamentation purposes, the ability to duplicate specific colors, over smaller scale productions, limits the ability to achieve cost economies associated with the development of specific high temperature suitable coatings associated with a particular team color. Accordingly, the ability to reduce the temperature of the upper surfaces may provide benefits with regard to the required temperature response characteristics of the selected coatings, thus reducing the overall cost of the novelty grill.

Although the present invention may be beneficially used for novelty grills used for festivities at sporting events, the utility of the present invention is not limited to such particular grills.

### SUMMARY OF THE INVENTION

The present invention is a barbecue grill, which utilizes a double wall in at least the upper portion of the grill in order to reduce the temperature of the outer surface of the upper portion of the grill, such that coatings applied to the upper surface are exposed to a reduced thermal characteristic.

In a simple embodiment, the present invention is embodied in a novelty grill having a coated exterior. The grill may include a lower portion having a heating member and a food support surface, and an upper portion, wherein the upper portion is engageable over the lower portion. The upper portion may have an outer shell and an inner shell and a vent, with the inner shell being displaced from the outer shell and flowably connected to the vent, with the positioning of the inner shell and the outer shell forming a chamber between the inner shell and the outer shell to reduce the heat transferred to the outer shell, wherein the outer portion is at least partially coated to provide a novelty aspect to the grill.

### BRIEF DESCRIPTION OF THE FIGURES

FIG. 1 illustrates an isometric view of a barbecue grill according to the present invention, showing the grill as having an aesthetic form associated with a sport.

FIG. 2 illustrates a side view of the barbecue grill of FIG. 1.

FIG. 3 illustrates a side view in cross-section of a barbecue grill according to the present invention, showing the inner wall of the upper shell of the barbecue grill.

FIG. 4 illustrates a side view in cross section of a barbecue grill according to the present invention, in which the upper portion has been rotated to provide access to the cooking chamber of the grill.

FIG. 5 illustrates a side view in cross section of a barbecue grill according to the present invention, in which the upper portion is hinged at its periphery.

FIG. 6 illustrates a side view in cross section of a barbecue grill according to the embodiment shown in FIG. 5, in which the upper portion has been rotated to provide access to the cooking chamber of the grill.

### DETAILED DESCRIPTION OF THE INVENTION

The present invention is a continuation in part of U.S. patent application Ser. No. 10/652,722, the contents of which are incorporated herein in their entirety by reference thereto.

The present invention relates to barbecue grills to which coatings are to be applied, such as for novelty or ornamental grills for use at tail-gate parties at sporting events. Accordingly, the present grill may provide benefits both as a result of being transportable, as well as by having a lowered temperature constraint for coatings applied to the upper surfaces. The reduced temperature constraints may allow less temperature resistant, more rugged coatings to be used on the upper portion, within cost requirements, thus allowing the grill design to be better tailored for the transportable novelty grill configuration.

As shown in the Figures, wherein like numbers represent like elements, the barbecue grill 100 of the present invention may be formed by an upper portion 102 and a lower portion 104. The lower portion 104 may be affixed to a stand 106, such that the grill 100 is held above the ground. The stand 106 may be designed to enhance the portability of the grill 100, such as by being adapted for engagement to a trailer hitch on a vehicle. The stand may have three legs 108, 110, 112 for stabilizing the grill 100 on the stand 106. One leg 108 may be adapted to be engaged to a trailer hitch receiver on a vehicle (not shown). The second 110 and third 112 legs may be positioned in an orientation non-perpendicular from the first leg 108, such that stability of the assembly is enhanced when the center of gravity of the grill 100 is approximately over the vertical element 114 of the stand 106.

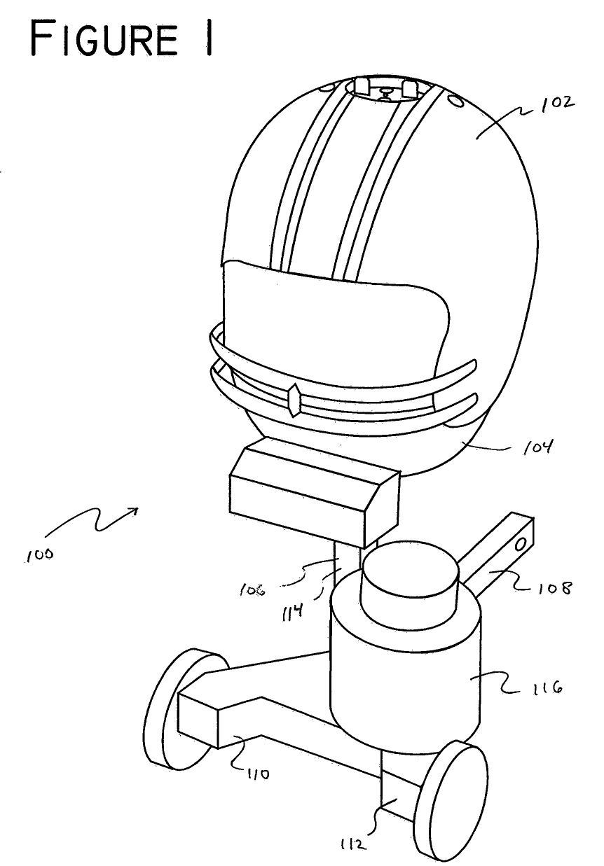

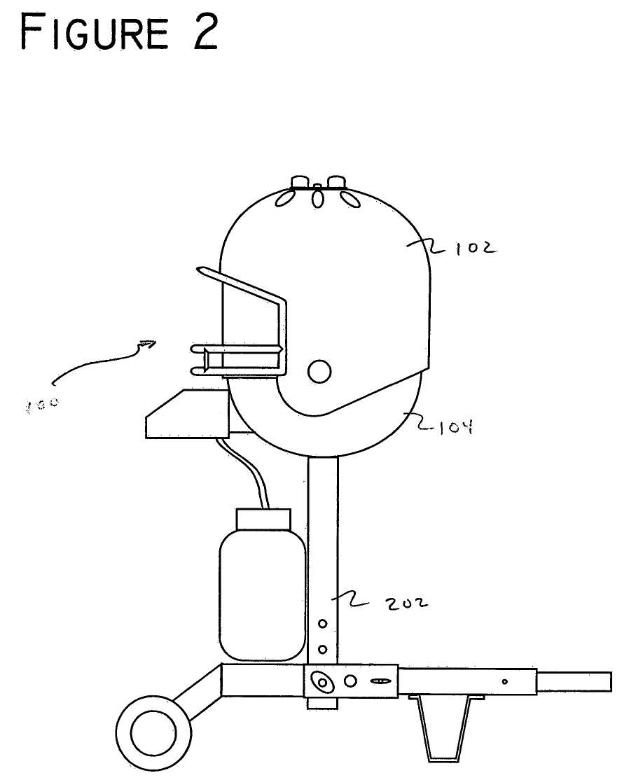

Provisions may be provided on one stabilizing leg (110 or 112) for attachment of a fuel source 116 for the grill 100, such as a propane or natural gas tank. The fuel source 116 is preferably removable from the stand 106, such that the fuel supply 116 may be removed from the stand 106 while the grill 100 is being transported. Placement of the fuel source 116 on one of the stabilizing legs (110 or 112) may be used to position the fuel supply 116 off center from the bottom of the grill 100, such that the presence of a drip hole (not shown in FIG. 1) at the lowest point of the lower portion 104 would not result in drips dropping onto the fuel source 116 itself. A variation on the embodiment of FIG. 1 is shown in FIG. 2, showing use of an adjustable height vertical element 202. The use of an adjustable height vertical element may assist in positioning the receiver portion 204 of the first leg 108 into a receiver hitch (not shown).

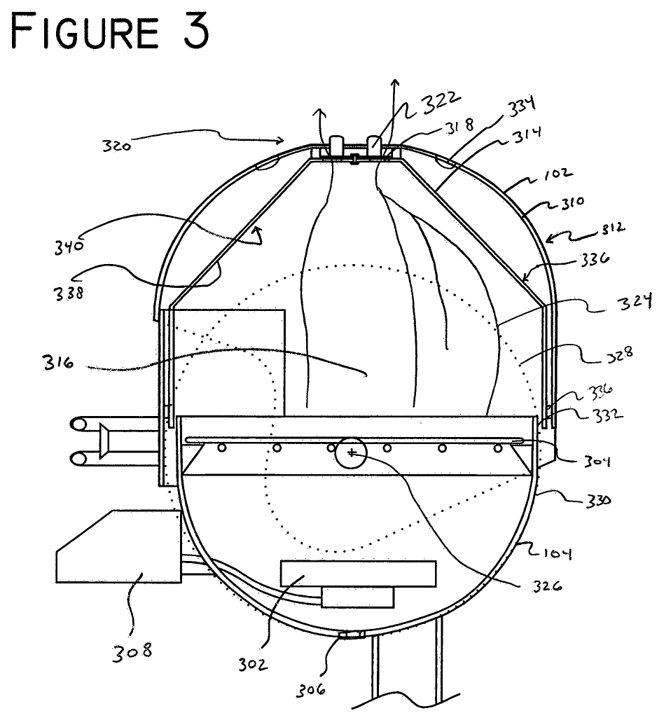

As shown in FIG. 3, the lower portion of the grill may have a heating member 302, such as a natural gas or propane burner, as well as a surface 304 for placement of foods to be cooked above the heating member 302. The heating member 302 may alternately be a solids combustion structure, such as a shelf for charcoal briquettes or pieces of wood. Alternately, the heating member may include structure for supporting jellied fuel containers.

The lower portion 104 of the grill 100 may include a drip hole 306 for allowing grease or other fluids to drain from the bottom portion 104. The drip hole may be sufficiently large to allow air flow to the heating member 302 to support any combustion occurring at the heating member 302. Where a gaseous fuel is used for the heating member 302, the lower portion 104 may further comprise a control panel 308 for the heating member 302.

The upper portion 102 may preferably have an outer shell 310, formed to provide an aesthetic display associated with a theme for the grill, onto which coatings 312 to accomplish the aesthetic function are applied. The upper portion 102 may additionally have an inner shell 314, acting as a barrier between the heating element 302 lower portion 104 and at least a portion of the upper shell 102. As the heating member 302 produces heat to cook food, the heat may be contained within the cooking chamber 316 of the grill 100. Heated gases typically rise, such that they enter the upper portion 102 of the grill 100. The heated gases, which may include combustion byproducts, moisture from foods being cooked, and smoke from the food being cooked, may be allowed to exit from the upper portion of the grill through a vent 318. The vent 318 may typically take the form of a hole or set of holes in the uppermost extent 320 of the upper portion 102, and may further include some form of a shutter 322 which allows the open cross-sectional area of the vent 318 to be varied, such that the air flow through the vent 318 can be controlled by a user of the grill. One typical form of a shutter 318 includes holes in a pattern which matches the pattern of the holes in the uppermost extent of the upper portion 102, where the holes in the shutter 322 are mounted in a rotatable plate, such that rotation of the plate allows the overlap of the holes of the shutter with regard to the holes in the uppermost extent of the upper portion to be varied.

The inner shell 314 of the upper portion 102 may be formed such that it acts as a chimney over the cooking surface 304 of the lower portion 104, and conducts heated gases along a path 324 away from the outer shell 310 of the upper portion 102. The form of the inner shell 314 may be dependant upon the method used to provide access to the cooking chamber formed by the upper portion 102 and the lower portions 104 of the grill 100.

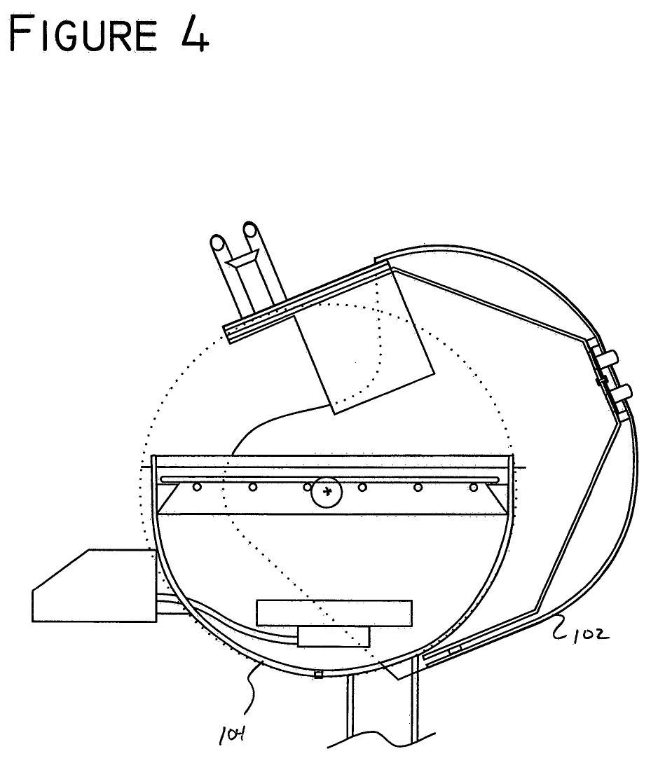

As shown in FIG. 3, the upper portion 102 of the grill 100 may be rotatable about an axis 326 extending through the center of the lower portion 104. Such a connection allows at least some balancing of the weight of the upper portion 102 about the axis of rotation 326, reducing the effort required to open the upper portion 102. When a centrally located axis of rotation is used, however, care must be made to ensure that unintentional interference between the inner shell 314 and the lower portion 104 does not exist such that it would preclude the intended rotation of the upper portion relative to the lower portion. The volume in which the upper portion and inner shell in particular should not intrude is defined by a solid of rotation 328 having as its diameter the most distant point 330 of the lower portion 104 which is in the path of some part of the upper portion 102 and/or inner shell 314. As shown in FIG. 3, where a hemispherical lower portion is implemented, the volume may be illustrated by the dashed circle 328. As shown in FIG. 4, rotation of the upper portion about the axis 324 may be accomplished where no interference is created between the lower portion 104 and the upper portion.

Returning to FIG. 3, the inner shell 314 may overlap the lower portion 104 to limit airflow between the inner shell 314 and the lower portion 104, to limit the escape of hot gasses between the inner shell 314 and the lower portion 104. The overlap may limit the escape of hot gases on the principal that hot gases rise, such that heated gases within the cooking chamber 316 will rise and exit through the vent, while cooler outside air may be pulled into the cooking chamber 316 through the gap 332 between the inner shell 314 and the lower portion 104. The gap 332 may be minimized to limit this air flow if desired.

Ports 334 may be provided in the outer shell 310 to allow the flow of air out from between the inner shell 314 and the outer shell 310. The ports 334 may preferably be placed at an uppermost extent 320 of the outer shell 310, such that heated gases may rise and exit from the ports 334. A seal 336 may be placed between the inner shell 314 and the outer shell 310 of the upper portion to provide stability in positioning between the inner shell 314 and the outer shell 310, however it is preferable to allow air flow between the inner shell 314 and outer shell when the inner shell 104 overlaps the lower portion, as the air flow may assist in cooling the outer shell 310. In such a condition, air heated by contact with the outer surface 336 of the inner shell 314 would rise and exit through the ports 334, thus pulling cooler air in through the lower gap 332 between the inner shell 314 and outer shell 310.

The inner shell 314 may further be provided with a temperature resistant coating 338 on the inner surface 340 of the inner shell 314, such as a metallic-ceramic coating which provides both insulative and heat reflecting properties. As heat generated by the heating member 302 may be transferred through radiant heat from the member 302 itself, the use of a heat reflective coating may reduce the temperature of the inner shell 314, reflecting the heat back into the cooking chamber 316, and further may reduce the heat required to be provided by the heating member 302 or cooking. The use of a coating 338 having insulative properties may additionally reduce the heat transfer through the inner shell 314, further reducing the temperature of the outer shell 310.

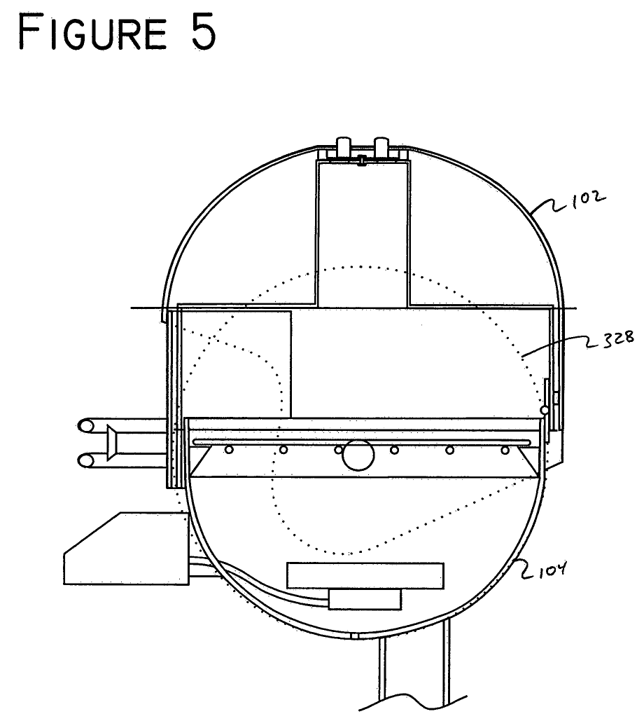

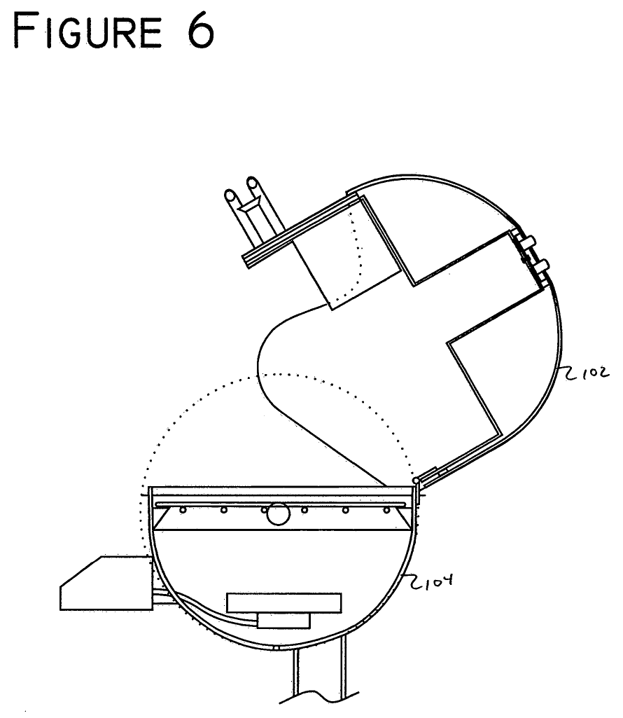

As shown in FIG. 5, the upper portion 102 may be affixed to the lower portion 104 through the use of a hinge 502 adjacent the perimeter 504 of the lower portion 104, such that the shape of the inner shell 506 may be varied as dictated by production concerns, as opposed to first having to meet the non-interference associated with a centrally rotated upper portion. The shape of the inner shell 506 thus becomes unconstrained with regard to the volume of the lower portion 104, and the inner shell 506 may take the form of a funnel, or other shape chosen for manufacturing concerns. Such an embodiment is further shown in FIG. 6, in which the upper portion 102 is shown in an open condition.

The present invention may be embodied in other specific forms without departing from the spirit or essential attributes of the invention. Accordingly, reference should be made to the appended claims, rather than the foregoing specification, as indicating the scope of the invention.

1. A novelty grill having a coated exterior, comprising:
a lower portion, the lower portion having a heating member and a food support surface;
an upper portion, said upper portion being engageable over the lower portion, said upper portion having an outer shell and an inner shell and a vent, said inner shell displaced from said outer shell and flowably connected to said vent, said positioning of said inner shell and said outer shell forming a chamber between said inner shell and said outer shell;
wherein said outer portion is at least partially coated to provide a novelty aspect to the grill.

2. A novelty grill according to claim 1, wherein said outer shell comprises at least one port, said port allowing air flow between said chamber and the environment.

3. A novelty grill according to claim 2, wherein said port comprises a plurality of ports located adjacent a topmost portion of the outer shell.

4. A novelty grill according to claim 3, wherein said inner shell has a lower edge adjacent said outer shell, further comprising a gap between said lower edge and said outer shell allowing air to flow between said lower edge and said outer shell.

5. A novelty grill according to claim 1, wherein said inner shell has an inner and an outer surface, said inner surface exposed to heat within the grill, wherein said inner shell is coated with a heat rejecting coating.

6. A novelty grill according to claim 5, wherein said heat-rejecting coating is a metallic-ceramic coating.

7. A novelty grill according to claim 1, wherein said lower portion has an upper perimeter, and wherein said inner shell has a lower perimeter, and wherein said lower perimeter is greater than said upper perimeter, such that hot gasses rising from the heating member enter the inner shell and flow out vent.

8. A novelty grill according to claim 1, wherein said lower portion is hemisperically shaped, said hemispherical shape having an upper perimeter, and wherein said inner shell is hemispherically shaped and a lower perimeter, and wherein said inner shell is rotatably engaged to said lower portion about an axis extending approximately through the center of the upper perimeter and the center of the lower perimeter.

9. A novelty grill according to claim 1, wherein said upper portion is hingedly affixed to said lower portion, and wherein said upper portion has open and closed positions relative to said lower portion, and wherein said inner shell abuts said lower portion when said upper portion is in a closed position.

10. A transportable grill comprising a lateral element, a vertical element, and a grill unit, the lateral element comprising a mounting element and a junction element, wherein said junction element allows traverse of the junction element relative to the vertical element to allow alternately positioning the junction element and associated lateral element in travel and use positions, and wherein said grill unit comprises a lower portion, the lower portion having a heating member and a food support surface, and an upper portion, said upper portion being engageable over the lower portion, said upper portion having an outer shell and an inner shell and a vent, said inner shell displaced from said outer shell and flowably connected to said vent, said positioning of said inner shell and said outer shell forming a chamber between said inner shell and said outer shell, wherein said outer portion is coated to provide a novelty aspect to the grill.

11. A transportable grill according to claim 10, wherein said junction element further comprises a locking feature for locking the position of the junction element relative to the vertical element.

12. A transportable grill according to claim 10, wherein said mounting element further comprises a retention feature to retain said mounting element in a receiver hitch when said mounting feature is engaged to a receiver hitch.

13. A transportable grill according to claim 10, wherein said transportable grill further comprises a lifting device for assisting a user in positioning the junction element relative to the vertical element.

14. A transportable grill comprising a lateral element, a vertical element, and a grill unit, wherein said lateral element further comprises a means for engaging a vehicle receiver for engaging said transportable grill to a vehicle, and wherein said lateral element further comprises a means for varying the position of the horizontal element relative to the vertical element.

15. A transportable grill according to claim 14, further comprising a means for fixing the position of the lateral element at at least one position relative to the vertical element.

16. A transportable grill according to claim 14, further comprising a means for retaining said lateral element in a vehicle receiver when said lateral element is engaged to said vehicle receiver.

17. A transportable grill according to claim 14, further comprising a means for lifting the vertical element relative to the lateral element to assist in positioning said transportable grill in a travel position.
